(19) United States
(12) Patent Application Publication
(10) Pub. No.: US 2017/0274869 A1
(43) Pub. Date: Sep. 28, 2017

(54) TAILGATE LOCK ASSEMBLY

(71) Applicant: Huf North America Automotive Parts Manufacturing Corp., Milwaukee, WI (US)

(72) Inventors: Lynn D. Da Deppo, Bloomfield Hills, MI (US); Ehab Kamal, Novi, MI (US); Jeffery T. Root, Howell, MI (US)

(21) Appl. No.: 15/081,395

(22) Filed: Mar. 25, 2016

(51) Int. Cl. B60R 25/00; B62D 33/027

(52) U.S. Cl. CPC B60R 25/00; B62D 33/0273

(57) ABSTRACT

A lock assembly for locking a tailgate relative to a body assembly of a vehicle includes a coupling member, a carriage, a trunnion, and a catch. The carriage is rotatably disposed within the coupling member and includes a first aperture and a first slot. The trunnion is removably received by the carriage and includes a second aperture aligned with the first aperture. The catch is movable between a locked position and an unlocked position. The catch is received by the first aperture and the second aperture in the locked position.

### FIELD

The present disclosure relates generally to a lock assembly and more particularly to a lock assembly for a vehicle having a tailgate or other removable closure.

### BACKGROUND

This section provides background information related to the present disclosure and is not necessarily prior art.

Many motor vehicles come equipped with tailgate assemblies. For example, pickup trucks often include a tailgate assembly that controls access to a bed portion of the pickup truck. In some implementations, tailgate assemblies are removably supported by the bed portion of the pickup truck. In this regard, the full functionality of the truck bed can be utilized by opening the tailgate assembly and/or removing the tailgate assembly from the pickup truck. The removability of tailgate assemblies can also make them vulnerable to car thieves. For this reason, locking systems have been developed to prevent inadvertent and other unwanted removal of the tailgate assembly from the vehicle. In this regard, some vehicles may utilize a handle locking system that prevents the tailgate assembly from opening, and thus prevents the tailgate assembly from being removed from the vehicle. Other vehicles may utilize a trunnion locking system that prevents the tailgate assembly from being removed, regardless of whether the tailgate is open or closed. Current handle locking systems are susceptible to being easily overridden and thus allowing unauthorized individuals to remove the tailgate assembly from the vehicle. Current trunnion locking systems provide an added degree of security as compared to handle locking systems; however, current trunnion locking systems do not allow authorized users to easily remove the tailgate assembly.

### SUMMARY

This section provides a general summary of the disclosure, and is not a comprehensive disclosure of its full scope or all of its features.

One aspect of the present disclosure provides a lock assembly for locking a tailgate relative to a body assembly of a vehicle. The lock assembly may include a coupling member, a carriage, a trunnion, and a catch. The carriage may be rotatably disposed within the coupling member and may include a first aperture and a first slot. The trunnion may be removably received by the carriage and may include a second aperture aligned with the first aperture. The catch may be movable between a locked position and an unlocked position. The catch may be received by the first aperture and the second aperture in the locked position.

Implementations of the disclosure may include one or more of the following features. In some implementations, the carriage is rotatable relative to the coupling member about a rotational axis and the catch is translatable relative to the coupling member along a translational axis. The rotational axis may be parallel to the translational axis.

In some implementations, the lock assembly includes a biasing member biasingly engaging the catch and configured to translate the catch along the translational axis.

In some implementations, the trunnion is operable to translate through the first slot in a direction perpendicular to the rotational axis when the catch is in the unlocked position.

In some implementations, the coupling member includes a second slot and a third aperture. The third aperture may be aligned with the first and second apertures and the catch may be received by the third aperture in the locked position. The trunnion may be coupled to the tailgate and the carriage may be coupled to the body assembly.

In some implementations, the catch includes a ramped surface configured to slidably engage an outer surface of the trunnion in the locked position.

In some implementations, the lock assembly includes a driver operable to translate the catch from the unlocked position to the locked position. The driver may include at least one of a motor and a solenoid. The lock assembly may include a control module operable to actuate the driver between a locking state and an unlocking state. The control module may include one of a key fob, a switch, and a key.

In some implementations, the catch is configured to rotate within the first aperture about a rotational axis.

Another aspect of the present disclosure provides a lock assembly for locking a tailgate relative to a body assembly of a vehicle. The lock assembly may include a carriage, a trunnion, and a catch. The carriage may include a trunnion-receiving feature and an aperture in communication with the trunnion-receiving feature. The trunnion may be received by the trunnion-receiving feature for translation along a first axis. The trunnion may include a second aperture aligned with the first aperture. The catch may be received by the first aperture and the second aperture for translation along a second axis transverse to the first axis. The catch may be movable between a locked position and an unlocked position along the second axis.

In some implementations, the catch is received by the first aperture and the second aperture in the locked position.

In some implementations, the lock assembly includes a coupling member. The carriage may be disposed within the coupling member for rotation about a third axis parallel to the second axis.

In some implementations, the coupling member includes a slot and a third aperture. The third aperture may be aligned with the first and second apertures. The catch may be received by the third aperture in the locked position.

In some implementations, the second axis is perpendicular to the first axis.

In some implementations, the lock assembly includes a biasing member biasingly engaging the catch and operable to translate the catch along the second axis.

In some implementations, the trunnion is operable to translate in a first direction within the trunnion-receiving feature when the catch is in the locked position and in a first direction and a second direction when the catch is in the unlocked position. The second direction may be opposite the first direction.

In some implementations, the trunnion is coupled to the tailgate and the carriage is coupled to the body assembly.

In some implementations, the catch includes a ramped surface configured to slidably engage an outer surface of the trunnion in the locked position.

In some implementations, a driver is operable to translate the catch from the unlocked position to the locked position.

Yet another aspect of the present disclosure provides a system for locking and unlocking a tailgate relative to a body of a vehicle. The tailgate may be movable between an open position and a closed position relative to the body. The system may include a latch system, a locking system, and a controller. The latch system may be operable between a locked state and an unlocked state. The latch system may permit the tailgate to rotate relative to the body in the unlocked state and prevent the tailgate from rotating relative to the body in the locked state. The locking system may be operable between a locked state and an unlocked state. The locking system may permit removal of the tailgate relative to the body when the latch system and the locking system are in the unlocked state. The locking system may prevent removal of the tailgate relative to the body when the latch system or the locking system are in the locked state. The controller may be in communication with at least one of the latch system and the locking system. The controller may be operable to control the at least one of the latch system and the locking system between the locked state and the unlocked state. The locking system may permit coupling the tailgate to the body when the locking system is in the locked state.

Another aspect of the present disclosure provides a security system for locking and unlocking a tailgate relative to a body assembly of a vehicle. Securing the tailgate may be transparently accomplished with the same securing operation that secures or locks one or more access locations (e.g., doors) of the vehicle. The security system may be motive driven by a power source to engage and disengage the tailgate with the body assembly while in any and all modes of tailgate orientation (e.g., open or closed) relative to the body assembly. The security system may allow removal of the tailgate from the body assembly only when the security system is in an UNLOCK state. The security system may allow securing of the tailgate to the vehicle independent of the LOCK/UNLOCK state of the security system and without performing addition operations beyond aligning a trunnion with a trunnion-receiving feature of a carriage.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1A is a perspective view of a vehicle having a tailgate and a tailgate lock assembly in accordance with the principles of the present disclosure, the tailgate shown in a latched state;

FIG. 1B is a perspective view of the vehicle of FIG. 1A, the vehicle shown in an unlatched state;

FIG. 2 is an exploded view of the tailgate lock assembly of FIG. 1A, including a trunnion in accordance with the principles of the present disclosure;

FIG. 3A is a cross-sectional view of the tailgate lock assembly of FIG. 1A in a locked position; and

FIG. 3B is a cross-sectional view of the tailgate lock assembly of FIG. 1A in an unlocked position.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

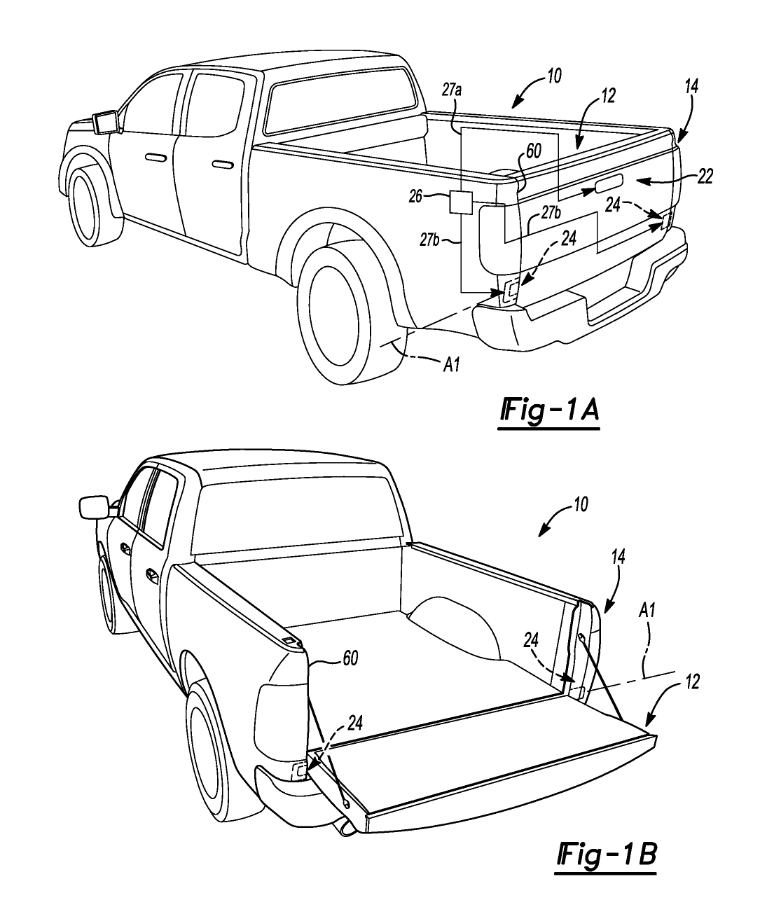

With reference to FIGS. 1A and 1B, a vehicle 10 is provided. The vehicle 10 may be any known variety of vehicle, such as a car, a truck, or a van for example. The vehicle 10 may include a closure 12 and a body assembly 14. The closure 12 may be movably coupled to the body assembly 14 to allow a user to access, and/or to prevent the user from accessing, a portion of the vehicle 10. In some configurations, the closure 12 may include a tailgate assembly movably coupled to, and/or supported by, the body assembly 14. In this regard, the closure 12 may be referred to herein as the tailgate assembly 12. Accordingly, the tailgate assembly 12 may allow the user to access, and/or prevent the user from accessing, a bed portion 16 of the vehicle 10.

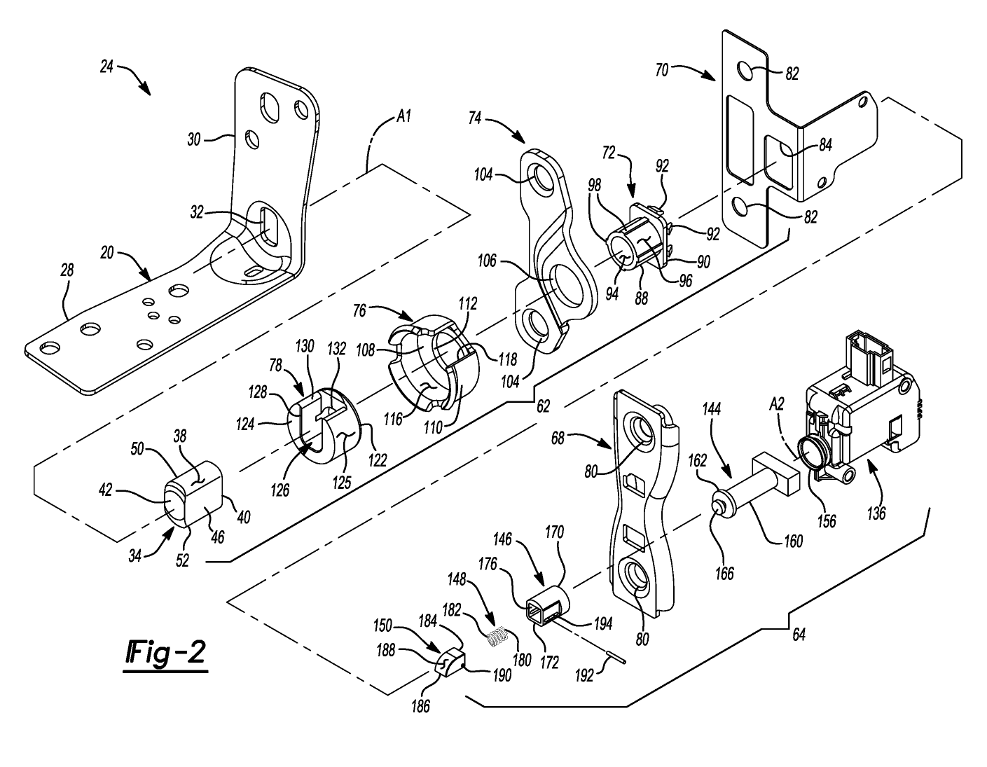

With reference to FIGS. 1A-2, the tailgate assembly 12 may include a pair of tailgate frame members 20, a latch assembly 22, and one or more lock assemblies 24. The tailgate assembly 12 may be coupled to the body assembly 14 for rotation about an axis A1. For example, the tailgate frame 20 may be rotatably supported by the lock assemblies 24 relative to the body assembly 14 such that the tailgate assembly 12 rotates between a closed position (FIG. 1A) and an open position (FIG. 1B). In this regard, opposed ends of the tailgate assembly 12 may each include a tailgate frame member 20 and a lock assembly 24. The latch assembly 22 may secure the tailgate assembly 12 relative to the body assembly 14 in order to prevent the tailgate assembly 12 from rotating about the axis A1 from the closed position to the open position. In this regard, as illustrated in FIG. 1A, a control module 26 may communicate with the latch assembly 22 and/or the lock assemblies 24 to control a state (e.g., LOCK/UNLOCK) of the latch assembly 22 and the lock assemblies 24. For example, the control module 26 may transmit (e.g., wired or wireless communication) (i) a LOCK/UNLOCK signal 27a to the latch assembly 22 to prevent and/or allow a user to rotate the tailgate assembly 12 from the closed position (FIG. 1A) to the open position (FIG. 1B) and (ii) a LOCK/UNLOCK signal 27b to the lock assembly 24 to prevent and/or allow a user to remove the tailgate assembly 12 from the vehicle 10.

As illustrated in FIG. 2, the tailgate frame 20 may include a base 28 and an arm 30 extending from the base 28 such that the frame 20 defines a generally L-shaped construct. The arm 30 may include an aperture 32. In some configurations the aperture 32 may be disposed proximate the base 28 and may include an elongate shape to receive a portion of the lock assembly 24. In this regard, the axis A1 may extend through the aperture(s) 32.

A first portion of the lock assemblies 24 may be coupled to the tailgate frame 20 and a second portion of the lock assemblies 24 may be coupled to the body assembly 14 such that the axis A1 extends through the first and second portions of the lock assemblies 24. In particular, each lock assembly 24 may include a coupling member or trunnion 34 disposed within one of the apertures 32.

With reference to at least FIG. 2, the trunnion 34 may include an outer surface 38 extending from a proximal end 40 to a distal end 42. The outer surface 38 may include, and/or otherwise be defined at least in part by, a first lateral wall 46, a second lateral wall (not shown), an upper wall 50, and a lower wall 52. The first lateral wall 46 may be opposite the second lateral wall. The lower wall 52 may extend from the first lateral wall 46 to the second lateral wall. The upper wall 50 may be opposite the lower wall 52 and extend from the first lateral wall 46 to the second lateral wall.

The first lateral wall 46 and the second lateral wall may each include a generally planar construct. In some configurations, the first lateral wall 46 may be parallel to the second lateral wall. The upper and lower walls 50, 52 may include a generally convex construct such that the trunnion 34 defines a generally stadium-shaped configuration extending from the proximal end 40 to the distal end 42.

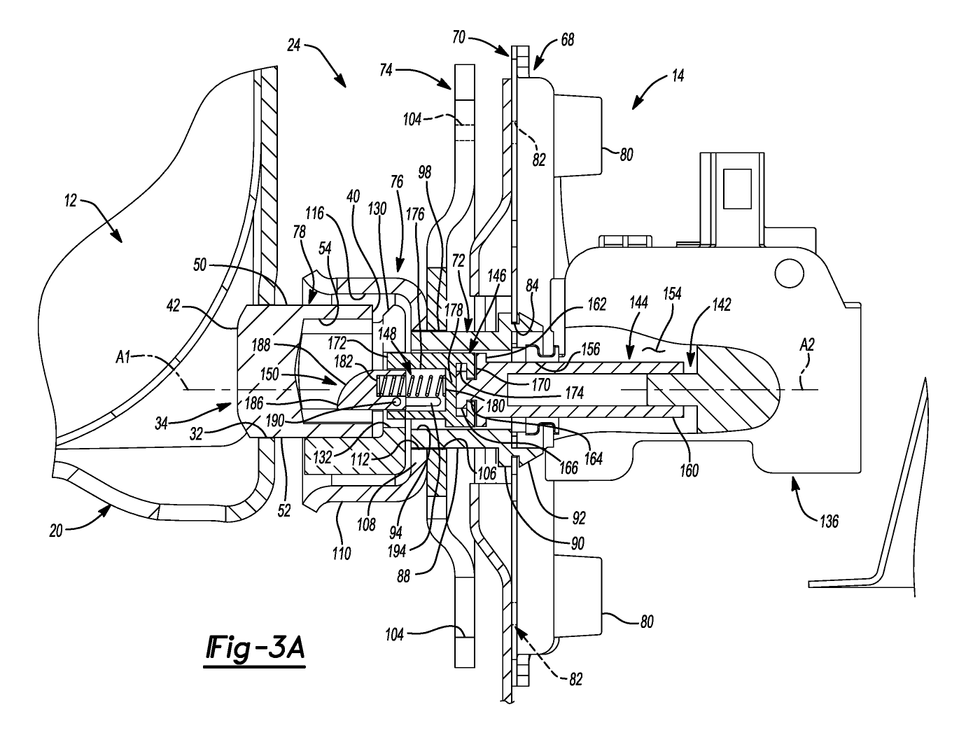

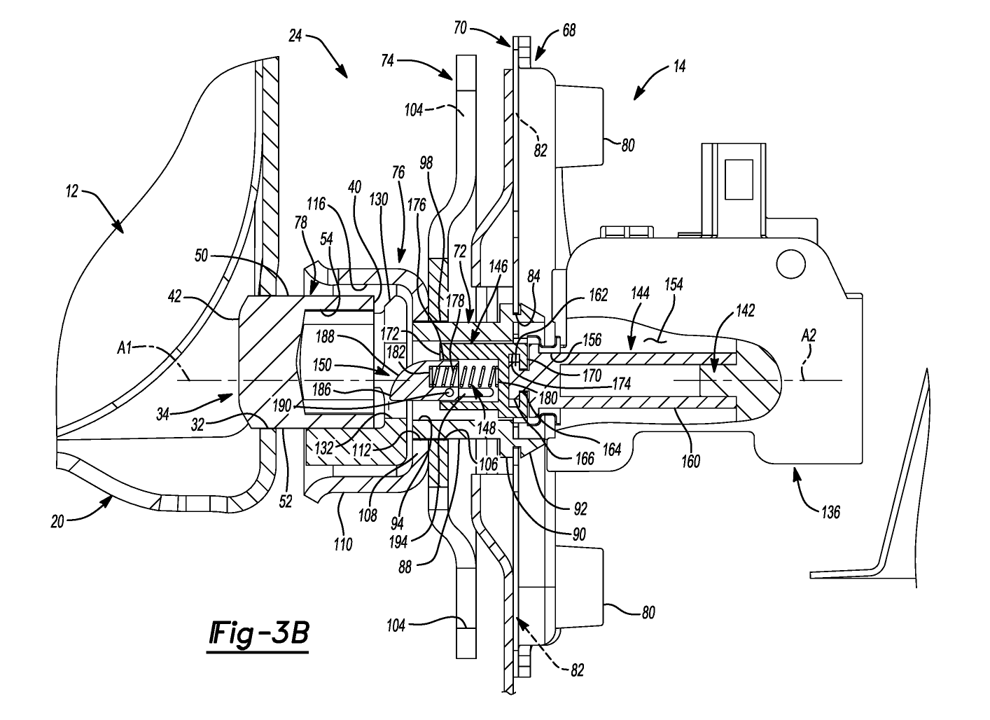

With reference to FIGS. 3A and 3B, the proximal end 40 of the trunnion 34 may include an aperture 54 such that the first lateral wall 46, the second lateral wall, and the upper and lower walls 50, 52 may substantially surround the aperture 54. In this regard, the aperture 54 may be substantially aligned with the axis A1.

With reference to FIGS. 1-3B, the body assembly 14 may include a body 60, a coupling assembly 62, and a lock assembly 64. The coupling assembly 62 may be coupled directly or indirectly to the body 60. In an assembled configuration, the trunnion 34 of the tailgate assembly 12 rotates relative to at least a portion of the coupling assembly 62, in order to allow the tailgate assembly 12 to rotate between the open position and the closed position. In this regard, while the tailgate assembly 12 and body assembly 14 are shown and described herein as including the lock assembly 24 and the coupling assembly 62, respectively, it will be appreciated that the tailgate assembly 12 may include the coupling assembly 62, and the body assembly 14 may include the lock assembly 24, within the scope of the present disclosure.

The coupling assembly 62 may include a bracket 68, a base plate 70, a support housing 72, a support plate 74, a coupling member 76, and a carriage 78. The bracket 68 may include one or more mounting features 80 (e.g., apertures) sized and shaped to receive a fastener (not shown), such as a bolt, screw, or rivet, for example, to couple the bracket 68 to the body 60. In this regard, it will be appreciated that the bracket 68 may be coupled to and/or supported by the body 60 using other techniques, such welding, press-fit, or clips, for example, within the scope of the present disclosure.

The base plate 70 may be coupled to and/or supported by the body 60 and may include one or more mounting features 82 (e.g., apertures) and a support housing-receiving feature 84 (e.g., aperture). The mounting feature 82 may be sized and shaped to receive a fastener (not shown), such as a bolt, screw, or rivet, for example, to couple the base plate 70 to the body 60 and the bracket 68.

The support housing 72 may include a generally hollow cylinder 88, a mounting flange 90, and one or more mounting features 92 (e.g., clips). The cylinder 88 may include a generally cylindrical inner surface 94, a generally cylindrical outer surface 96, and one or more engagement features 98. The engagement feature(s) 98 (e.g., longitudinally extending ribs) may extend radially outward from the outer surface 96. The mounting flange 90 may extend radially outward from the outer surface 96. The one or more mounting features 92 (e.g., clips) may extend axially from the mounting flange 90, away from the cylinder 88. As illustrated in at least FIGS. 3A and 3B, in the assembled configuration, the mounting features 100 may be disposed within the housing-receiving feature 84 to secure the support housing 72 to the base plate 70.

The support plate 74 may include a one or more mounting features 104 (e.g., apertures) and a support housing-receiving feature 106 (e.g., an aperture). In the assembled configuration, the mounting feature(s) 104 may be aligned with the mounting feature(s) 82 of the base plate 70 and/or the mounting features 80 of the bracket 68, such that each fastener (not shown) extends through a mounting feature 104 of the support plate 74 and a mounting feature 80, 82 of the bracket 68 and base plate 70, respectively, in order to secure the support plate 74 to the base plate 70 and to secure the base plate 70 to the body 60. The housing-receiving feature 106 may receive the support housing 72 in order to secure the support housing 72 to the support plate 74. In this regard, the support housing 72 may be disposed within the housing-receiving feature 106 such that the engagement feature(s) 98 engage the support plate 74 in a press-fit configuration.

As illustrated in FIG. 2, the coupling member 76 may include a base portion 108 and a support portion 110. The base portion 108 may include a support-housing receiving feature 112 (e.g., an aperture). With reference to FIGS. 3A and 3B, in the assembled configuration, the support housing-receiving feature 112 may receive the support housing 72 in order to secure the support housing 72 to the coupling member 76. In this regard, the support housing 72 may be disposed within the support housing-receiving feature 112 such that the engagement feature(s) 98 engage the coupling member 76 in a press-fit configuration.

The support portion 110 may extend from the base portion 108 of the coupling member 76 and may define a generally hollow cylindrical construct. In this regard, the support portion 110 may include a cylindrical inner surface 116 and a slot 118. The inner surface 116 may surround the support-housing receiving feature 112. The slot 118 may extend through the support portion 110. As will be explained in more detail below, in the assembled configuration, the slot 118 may allow a user to assemble the tailgate assembly 12 to, and/or remove the tailgate assembly 12 from, the body assembly 14.

With reference to FIG. 2, the carriage 78 may include a proximal end 122, a distal end 124 opposite the proximal end 122, a peripheral surface 125, and a trunnion-receiving feature 126 (e.g., a slot). As illustrated in FIGS. 3A and 3B, in the assembled configuration, the carriage 78 may be disposed within the coupling member 76 for rotation about the axis A1. The peripheral surface 124 may extend from and between the proximal and distal ends 122, 124.

The trunnion-receiving feature 126 may be formed in one or more of the proximal end 122 and the peripheral surface 125. In this regard, the trunnion-receiving feature 126 may include an opening 128 formed in the distal end 124 of the carriage 78 and an opening 130 formed in the peripheral surface 125 of the carriage 78. In some configurations, the opening 128 and/or the opening 130 may be generally U-shaped such that the opening 128 communicates with and/or opens into the opening 130. The distal end 124 of the carriage 78 may include an aperture 132. The aperture 132 may open into and/or communicate with the trunnion-receiving feature 126, including the opening 128 formed in the proximal end 122 of the carriage 78. A size and shape of the trunnion-receiving feature 126 may correspond to a size and shape of the trunnion 34 such that the trunnion 34 can be received by the openings 128, 130 in order to assemble the trunnion 34 within, and remove the trunnion 34 from, the trunnion-receiving feature 126.

As illustrated in FIGS. 3A and 3B, in the assembled configuration, the carriage 78 may be disposed within the coupling member 76 such that the axis A1 extends through the proximal and distal ends 122, 124. In this regard, in some configurations the axis A1 may extend through the aperture 132 and the opening 128. As will be explained in more detail below, the carriage 78, including the trunnion-receiving feature 126 and the aperture 132, may cooperate with the lock assembly 64 to allow the tailgate assembly 12 to be removed from, and/or to prevent the tailgate 18 from being removed from, the body assembly 14.

With reference to FIG. 2, the lock assembly 64 may include a housing 136, a driver 142, a pin 144, a holder 146, a biasing member 148, and a catch 150. As illustrated in FIGS. 3A and 3B, in the assembled configuration, the lock assembly 64 may be coupled to the body 60 and/or the coupling assembly 62. The housing 136 may include a generally hollow construct having an inner chamber 154 and an aperture 156 in communication with the inner chamber 154. As will be explained in more detail below, the aperture 156 may define a translational axis A2 extending through the chamber 154 of the housing 136. The translational axis A2 may be parallel to and/or collinear with the axis of rotation A1.

The driver 142 may be any variety device and/or assembly configured to move the pin 144 along the axis A2 (e.g., parallel to the axis A2). For example, the driver 142 may include a motor, a solenoid, a pneumatic actuator, or other device that can apply a force on the pin 144 in a direction substantially parallel to the axis A2. In the assembled configuration, the driver 142 may be disposed within the housing 136.

As illustrated in FIG. 2, the pin 144 may include a shaft 160, a flange 162, a groove 164, and a head 166. With reference to FIGS. 3A and 3B, in the assembled configuration, a portion of the pin 144 may be disposed within the chamber 154 of the housing 136 such that the pin 144 extends through the aperture 156. The pin 144 may be further disposed within the hollow cylinder 88 of the support housing 72 such that the pin 144 can be translated within the hollow cylinder 88 along the axis A2. The flange 162 may extend radially outward from the shaft 160. In this regard, the flange 162 and the groove 164 may each define an annular configuration generally surrounding the shaft 156. The groove 164 may be disposed between the flange 162 and the head 166 such that the groove 164 defines, at least in part, the head 166.

With reference to FIG. 2, the holder 146 may include generally hollow cylindrical construct extending from a proximal end 170 to a distal end 172. As illustrated in FIGS. 3A and 3B, the proximal end 170 may include a proximal cavity 174 and the distal end 172 may include a distal cavity 176. The proximal cavity 174 may be separated from the distal cavity 176 by a radially inward extending wall 178.

In the assembled configuration, the holder 146 may be translatably disposed within one or more of the support housing 72 and the carriage 78 for translation along the axis A2. In this regard, the pin 144 may be coupled to the holder 146 such that translation of the pin 144 causes the holder to translate along the axis A2. For example, the head 166 of the pin 144 may be rotatably disposed within the proximal cavity 174 such that (i) translation of the pin 144 causes the head 166 and/or the flange 162 to engage the holder 146 in order to translate the holder 146 along the axis A2, and (ii) rotation of the holder 146 about the axis A2 causes the head 166 to rotate within the cavity 174 and causes the catch 150 to rotate about the axis A2.

With reference to FIG. 2, in some implementations, the biasing member 148 may include a helical spring extending from a proximal end 180 to a distal end 182. It will be appreciated, however, that the biasing member 148 may include other configurations (e.g., a leaf spring, a torsion spring, etc.) within the scope of the present disclosure. As illustrated in FIGS. 3A and 3B, in the assembled configuration, the biasing member 148 may be disposed within the distal cavity 176 such that the proximal end 180 engages the wall 178 and the distal end 182 engages the catch 150.

As illustrated in FIG. 2, the catch 150 may extend from a proximal end 184 to a distal end 186. The distal end 186 may include a ramped surface 188. In some implementations, the ramped surface 188 surface may include an arcuate (e.g., convex) construct. With reference to FIGS. 3A and 3B, in the assembled configuration, the catch 150 may be translatably disposed within the proximal cavity 176 of the holder 146. In this regard, in some implementations, the catch may include an aperture 190 (e.g., a through hole) extending in a direction generally perpendicular to the axis A2. The aperture 190 may receive a pin 192. In the assembled configuration, opposed ends of the pin 192 may be received by opposed tracks 194 formed in the holder 146. As illustrated, the tracks 194 may extend in a direction generally parallel to the axis A2 in order to allow the catch 150 to translate within the proximal cavity 176.

With continued reference to FIGS. 1A-1B and 3A-3B, operation of the tailgate assembly 12 will now be described. In a first state, the tailgate assembly 12 may be coupled to the body assembly 14 in a closed position (FIG. 1A) or an open position (FIG. 1B), and the catch 150 may be disposed within the aperture 54 of the trunnion 34 in a locked position (FIG. 3A). Accordingly, the catch 150 may prevent movement of the tailgate assembly 12 relative to the body assembly 14 in a direction generally perpendicular to the axis A2 still allowing rotational movement of the tailgate assembly 12 relative to the body assembly 14 about the axis A1.

In order to unlock the tailgate assembly 12 relative to the body assembly 14 (e.g., in order to remove the tailgate assembly 12 from the body assembly 14), the user may actuate the driver 142. In this regard, the user may actuate the driver 142 using a mechanical (e.g., a key) or electronic (e.g., a key fob) communication device. For example, the user may utilize the control module 26 to transmit the UNLOCK signal 27b to the lock assembly 24 and to actuate the driver 142 in order to allow a user to remove the tailgate assembly 12 from the vehicle 10. In this regard, actuating the driver 142 may cause the pin 144 to move along the axis A2 (e.g., away from the trunnion 34). As the pin 144 moves along the axis A2, the catch 150 may exit the aperture 54 of the trunnion 34 and move to an unlocked position (FIG. 3B). In this regard, in the unlocked position, the catch 150 may be disposed within the support housing 72 and/or the aperture 132 of the carriage 78.

Once the catch 150 has exited the aperture 54 of the trunnion 34, the user may move the trunnion 34 and/or the tailgate assembly 12 in a direction generally perpendicular to the axis A2. For example, the user may lift the tailgate assembly 12 relative to the body assembly 14, such that the trunnion 34 (i) exits the trunnion-receiving feature 126 of the carriage 78 through the opening 130 and (ii) exits the coupling member 76 through the slot 118.

In a second state, the tailgate assembly 12 may have been removed from the body assembly 14, and the catch 150 may be positioned in the locked position (FIG. 3A) or the unlocked position (FIG. 3B). In order to couple the tailgate assembly 12 to the body assembly 14, the user may move the tailgate assembly 12 relative to the body assembly 14 in a direction generally perpendicular to the axis A2 until the trunnion 34 (i) enters the trunnion-receiving feature 126 of the carriage 78 through the opening 130 and (ii) enters the coupling member 76 through the slot 118.

If the catch 150 is in the locked position (FIG. 3A) when the tailgate assembly 12 is in the second state, the trunnion 34 will engage the ramped surface 188 of the catch 150 upon entering the trunnion-receiving feature 126 of the carriage 78. Upon engaging the ramped surface 188 of the catch 150, the trunnion 34 can slide along the ramped surface 188 and apply a force on the catch 150 in a direction extending substantially parallel to the axis A2. The force applied on the catch 150 by the trunnion 34 can urge the catch 150 towards the wall 178 of the holder 146. In particular, the pin 192 may translate within and/or relative to the tracks 194 along the axis A2.

As the catch 150 moves towards the wall 178 of the holder 146, the biasing member 148 is compressed by and between the wall 178 and the catch 150 until the catch 150 exits the trunnion-receiving feature 126 of the carriage 78. Once the catch 150 has exited the trunnion-receiving feature 126 of the carriage 78, the trunnion 34 enters the trunnion-receiving feature 126 of the carriage 78 until the aperture 54 of the trunnion 34 is aligned with the aperture 132 of the carriage 78. In particular, the trunnion 34 enters the trunnion-receiving feature 126 until the axis A2 intersects the aperture 54 of the trunnion 34 and the aperture 132 of the carriage 78. Once the aperture 54 of the trunnion 34 is aligned with the aperture 132 of the carriage 78, the biasing member 148 urges the catch 150 to translate in a direction substantially parallel to the axis A2, and away from the wall 178 of the holder 146, until the catch 150 enters the aperture 54 of the trunnion 34.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A securing system for a vehicle including a vehicle body rotatably supporting a tailgate between an open position and a closed position relative to the vehicle body, the securing system comprising:
a latch mechanism operable between a latched state restricting rotation of the tailgate relative to the vehicle body from the closed position to the open position and an unlatched state permitting rotation of the tailgate relative to the vehicle body from the closed position to the open position;
a locking mechanism operable between a locked state preventing removal of the tailgate from the vehicle body and an unlocked state permitting removal of the tailgate from the vehicle body when the latch mechanism is in the unlatched state; and
a controller in communication with the locking mechanism and operable to move the locking mechanism between the locked state and the unlocked state.

2. The securing system of claim 1, wherein the locking mechanism is biased into the locked state.

3. The securing system of claim 2, wherein the tailgate is operable to be attached to the vehicle body when the locking mechanism is in the locked state or the unlocked state.

4. The securing system of claim 1, wherein the tailgate is operable to be attached to the vehicle body when the locking mechanism is in the locked state or the unlocked state.

5. The securing system of claim 1, further comprising a driver in communication with the controller, the driver operable to move the locking mechanism from the locked state to the unlocked state.

6. The securing system of claim 5, wherein the driver is a solenoid or a reversing motor.

7. The securing system of claim 6, wherein the locking mechanism includes a locking element movable between an extended position when the locking mechanism is in the locked state and a retracted position when the locking mechanism is in the unlocked state, the locking element being moved from the extended position to the retracted position in a first direction away from the tailgate by the driver.

8. The securing system of claim 7, wherein the locking element is biased into the extended position in a second direction opposite to the first direction toward the tailgate by a biasing member.

9. A securing system for a vehicle including a vehicle body rotatably supporting a tailgate between an open position and a closed position relative to the vehicle body, the securing system comprising:
a latch mechanism operable between a latched state restricting rotation of the tailgate relative to the vehicle body from the closed position to the open position and an unlatched state permitting rotation of the tailgate relative to the vehicle body from the closed position to the open position;
a locking mechanism operable between a locked state preventing removal of the tailgate from the vehicle body and an unlocked state permitting removal of the tailgate from the vehicle body when the latch mechanism is in the unlatched state, the locking mechanism permitting the tailgate to be attached to the vehicle body when the locking mechanism is in the locked state or the unlocked state.

10. The securing system of claim 9, wherein the locking mechanism is biased into the locked state.

11. The securing system of claim 9, further comprising a controller in communication with the locking mechanism and operable to move the locking mechanism between the locked state and the unlocked state.

12. The securing system of claim 11, further comprising a driver in communication with the controller, the driver operable to move the locking mechanism from the locked state to the unlocked state.

13. The securing system of claim 12, wherein the driver is a solenoid or a reversing motor.

14. The securing system of claim 13, wherein the locking mechanism includes a locking element movable between an extended position when the locking mechanism is in the locked state and a retracted position when the locking mechanism is in the unlocked state, the locking element being moved from the extended position to the retracted position in a first direction away from the tailgate by the driver.

15. The securing system of claim 14, wherein the locking element is biased into the extended position in a second direction opposite to the first direction toward the tailgate by a biasing member.

16. A method comprising:
positioning a latch mechanism in an unlatched state to permit rotation of a tailgate from a closed position to an open position relative to a vehicle body; and
supplying a signal to a locking mechanism via a controller to move the locking mechanism from a locked state preventing removal of the tailgate from the vehicle body to an unlocked state permitting removal of the tailgate from the vehicle body when the latch mechanism is in the unlatched state.

17. The method of claim 16, wherein moving the locking mechanism from the locked state to the unlocked state includes energizing a driver to move a locking element of the locking mechanism from an extended state to a retracted state.

18. The method of claim 17, wherein energizing a driver includes supplying electrical power to a solenoid to move the locking element from the extended state to the retracted state.

19. The method of claim 17, wherein moving the locking element from the extended state to the retracted state includes moving the locking element in a direction away from the tailgate.

20. The method of claim 17, further comprising biasing the locking element into the extended state.

21-42. (canceled)
